(19) United States
(12) Patent Application Publication
(10) Pub. No.: US 2009/0235719 A1
(43) Pub. Date: Sep. 24, 2009

(54) CO2 ABSORPTION DEVICE FOR ELEMENTAL ANALYSIS INSTRUMENTS

(75) Inventors: Paolo Magni, Rodano (IT); Martino Villa, Rodano (IT); Giacinto Zilioli, Rodano (IT)

Correspondence Address: LUCAS & MERCANTI, LLP, 475 PARK AVENUE SOUTH, 15TH FLOOR, NEW YORK, NY, 10016, US

(73) Assignee: THERMO ELECTRON S.P.A., Rodano (IT)

(21) Appl. No.: 12/297,913

(22) PCT Filed: Sep. 5, 2006
(86) PCT No.: PCT/IB2006/002455

§ 371 Date: Jan. 30, 2009

(30) Foreign Application Priority Data
Apr. 21, 2006 (IT) MI2006A 000813

(51) Int. Cl. G01N 30/04

(52) U.S. Cl. 73/23.42

(57) ABSTRACT

The invention relates to a CO₂-absorption device within an elemental analysis instrument, comprising at least one combustion reactor and one detector, connected by a pneumatic line for the gasses undergoing analysis emerging from the combustion reactor, along which said CO₂-absorption device is arranged downstream of the combustion reactor and upstream of the detector. In order to accelerate the operational cycle and improve efficiency without excessive bulk, two regenerable CO₂ filters, valve means for feeding the gasses undergoing analysis to one of said filters, alternating between one another for each analysis, and for supplying a regenerating flow of wash gas to the second filter, in the opposite direction with respect to the direction of flow of the gas undergoing analysis in the same filter are envisaged, as well as means for temporarily heating the filter during the regeneration stage.

### BACKGROUND OF THE INVENTION

1. Field of the Invention

The present invention concerns a CO₂ absorption device suitable for operation in an elemental analysis instrument, especially for nitrogen determination, particularly an instrument based on the Dumas method. Such an instrument consists of a high temperature sample combustion reactor with a current of oxygen, where the combustion gasses pass into a reduction reactor with the elimination of water, carbon dioxide and any SO₂ present, prior to the gas being sent to a detector, particularly a nitrogen detector.

2. Description of the Prior Art

The use of chemical filters for CO₂ elimination, which are simply replaced following a certain number of analytical cycles, are known in the art. However, such filters have a number of drawbacks, especially for high weight samples (for example 1-2 g of cereals) since the quantity of CO₂ to be absorbed demands large filters, which have a negative impact on analytical performance. Furthermore, the reaction with large quantities of CO₂ can be highly exothermic and lead to the curing of the absorbent material with increased load loss. The resulting increase in combustion reactor operating pressure reduces the conversion efficiency of the sample into elemental gas. Sending only a percentage of the combustion gas to the filter has been proposed as a solution for obviating such drawbacks, but this influences the accuracy and reproducibility of the analyses, and leads to further complications in the instrument pneumatics.

CO₂ filters, acting at the physical level, which can be regenerated by means of heating and passing regenerative gas through, have also been proposed. In cases involving large quantities of CO₂, such filters must necessarily also have large dimensions, and require long periods of time (of the order of 15 minutes) for their regeneration and subsequent cooling. Furthermore, it is practically essential to provide an upstream water filter, since the CO₂ filter would absorb water more or less irreversibly, with consequential degradation of efficiency.

Patent application EP 1586895 illustrates an elemental analysis instrument envisaging a carousel with a number of regenerable CO₂ filters, which are brought in succession into the operating position and then into the regeneration position. This solution allows reduced regeneration times, and the ability to move from one analysis to the next without pausing. However, there are problems with the pneumatic seals and, in the case of heavy samples, the device requires individual, large sized filters and therefore has a tendency to be excessively bulky.

### SUMMARY OF THE INVENTION

The scope of the present invention is therefore that of providing a device for absorbing CO₂, intended for use in an elemental analysis instrument, that is both regenerable, capable of operating without any moving parts, with high efficiency, and does not require any time for regeneration between one analysis and the next, even for high weight samples.

These scopes, and others, which will become evident from the following description, are achieved by a CO₂ absorption device according to claims 1 to 16 operating in an elemental analysis instrument according to claims 17 to 20.

### DRAWINGS

The device and the instrument according to the invention will be described with reference to a preferred embodiment, illustrated schematically, purely by way of non-limiting illustration, in the attached figures, in which:

FIG. 1 is a diagram of an elemental analyser fitted with a CO₂ absorption device according to the invention.

FIGS. 2 and 3 are schematic illustrations of the absorption and regeneration supply methods for the filters making up the device according to the invention.

FIGS. 4 and 5 schematically depict a control valve for the filters operating in accordance with FIGS. 2 and 3.

FIG. 6 depicts an example of a CO₂ absorption filter according to the invention.

### DESCRIPTION OF THE PREFERRED EMBODIMENTS

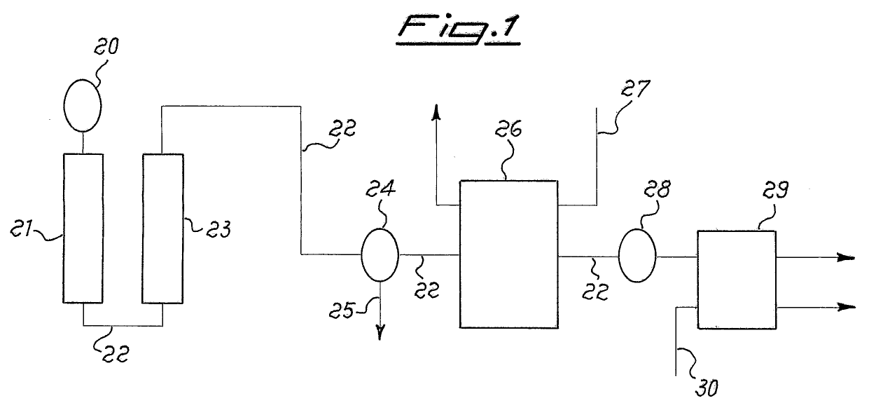

The diagram in figure FIG. 1 refers to an elemental analysis instrument, in the configuration shown, with an automatic sampler 20 capable of sending samples one at a time to an oxidation reactor 21 maintained at a high temperature (approx. 1000° C. or higher). At the same time, the supply of carrier gas, generally consisting of helium, is switched to supplying oxygen in order to achieve the so-called very high temperature “flash” combustion in the reactor 21. The combustion gasses are then sent, by means of a pneumatic line 22 borne by the carrier, to a reduction reactor 23, downstream of which the carrier transports the “elemental” gasses, N₂, CO₂, H₂O and possibly SO₂, by means of said line 22.

A water condenser 24 is fitted to the line 22 in order to remove condensed water, and discharge it externally by means of line 25. Line 22 then feeds gas to the device 26 which handles the absorption of the CO₂, any remaining water and any SO₂, if present

The device 26 has two filters, one involved in the absorption stage and one undergoing regeneration by means of heating and passing through a regenerating gas, which may be the same helium carrier, supplied and exhausted by means of line 27. A gas chromatography column 28 and a detector 29, to which a reference gas is also supplied by means of line 30, are arranged downstream in the known manner.

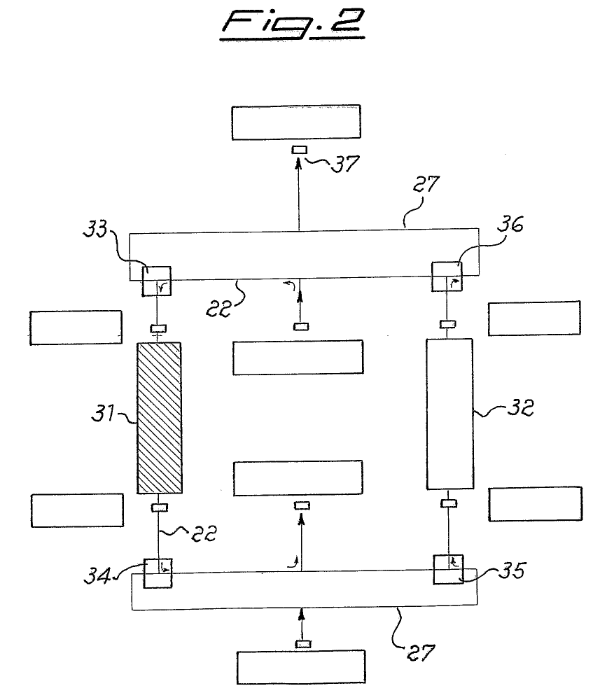

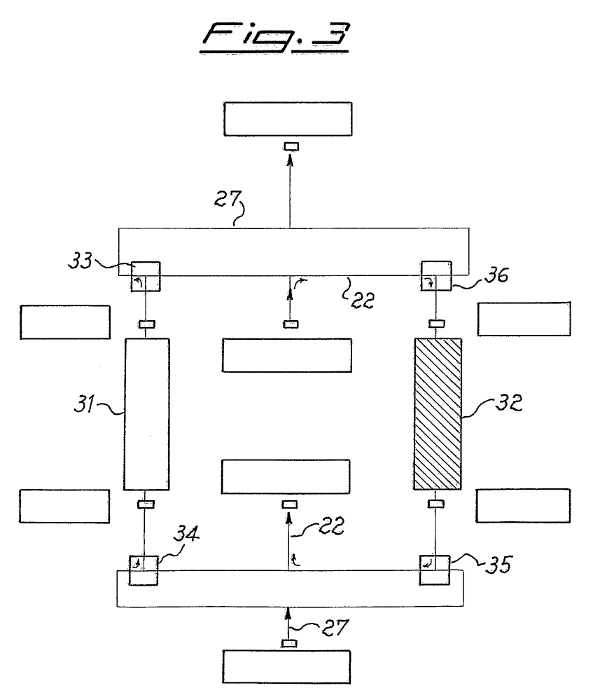

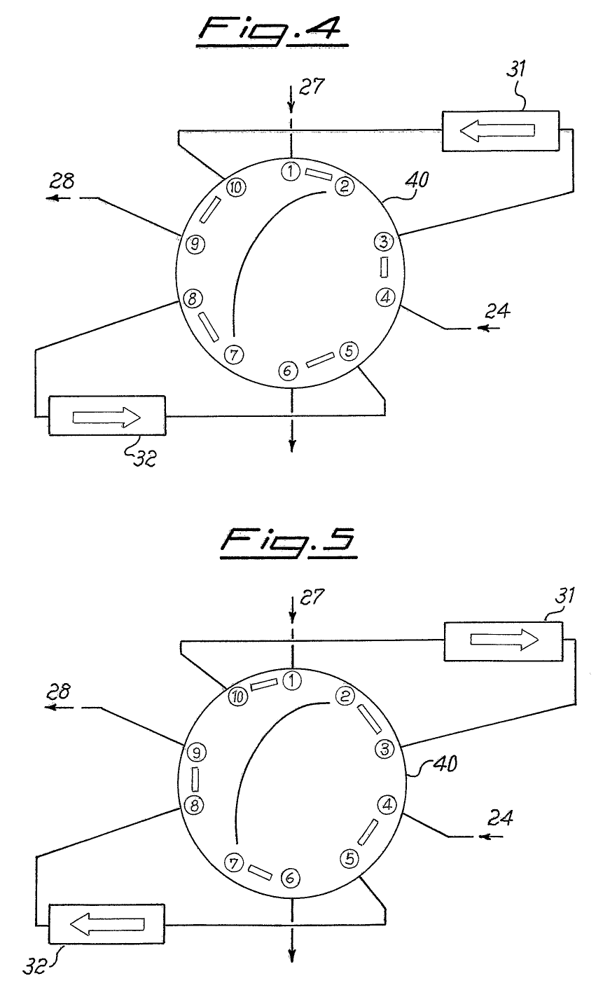

The device 26 is shown schematically in FIGS. 2 and 3. It consists of two regenerable filters 31 and 32 and pneumatic connections for supplying the same with the combustion gasses and with the regenerating gas. More precisely, with reference to FIG. 2, the filter 31, in absorption mode, is fed using line 22 coming from the water condenser 24 by means of a three-way, two position electrovalve 33. On emerging from the first electrovalve, the gas passes through a second three-way, two position electrovalve 34 in order to be fed to the gas chromatography column 28. At the same time, the regenerating gas (helium) is fed into the second filter 32 by means of line 27 through a third, three-way, two position electrovalve 35, while the exhaust from the filter 32 is discharged to 37 under the control of a fourth, three-way, two position valve.

FIG. 3 shows the set-up for absorption by filter 32 and regeneration of filter 31, obtained by switching over the four electrovalves 33-36. In this case, the combustion gas is fed into filter 32 by means of electrovalve 36 and sent to the gas chromatography column by means of electrovalve 35. The regenerating carrier is fed into filter 31 by means of electrovalve 34 and exhausted by means of electrovalve 33.

It should be observed that the pneumatic connections shown operate in such a way that filter regeneration always occurs with a flow of carrier in the opposite direction with respect to the flow of gas during the absorption stage for the same filter. This is very important since, as will be appreciated below, it allows improved regeneration conditions, and hence improved device operating conditions.

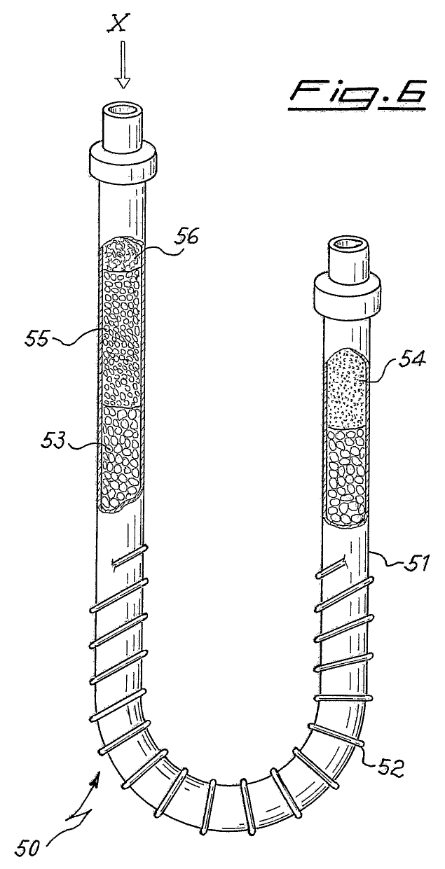

In FIGS. 4 and 5, valves 33-36 are replaced by a single 10-ways, two position valve 40.

In the first position shown in FIG. 4, the regeneration gas, coming in through port 1, is directed, by means of ports 2, 7 and 8—through the filter 32 and then from the latter, by means of ports 5 and 6, to exhaust. At the same time, the gasses emerging from the water condenser 24 are sent, by means of ports 4 and 3 to the filter 31 during the analytical stage, and then from the latter, by means of ports 10 and 9, to the gas chromatography column 28. In the position shown in FIG. 5, the valve 40 sets the filter 31 in the conditions for regeneration by supplying the regenerating gas, by means of ports 1, 10, 3, 2, 7 and 6, while the filter 32 is in analytical mode, and the gasses coming out of the water condenser 24 by means of ports 4 and 5 pass through it and are then conveyed to the gas chromatography column 28 by means of ports 8 and 9.

With reference to FIG. 6, each filter 50 consists of an elongated tubular element 51 with an internal diameter preferably comprised of between 4 mm and 10 mm, and length between 50 and 200 cm, optionally folded over into a U-shape for reasons of bulk. The tubular element is made from thermoconductive material, for example a metal, preferably steel, wound around the outer surface of which is at least one heating element 52, preferably a single wire playing the simultaneous roles of heating element and temperature measuring element during regeneration.

The interior volume of the tube is filled with a packing composed of one or more CO₂-absorbent materials arranged and/or selected so as to provide a CO₂ absorbent power that increases from the filter inlet to the filter outlet in the direction, marked X, taken by the gas during the analysis stage. In particular, said material may be comprised of molecular sieves with granulometry that decreases from the inlet to the outlet in the aforementioned direction, in particular, for example, two different granulometries, as shown the larger in 53 and the finer in 54, respectively.

Still in the direction undertaken by the gas undergoing analysis, upstream of the CO₂-absorbent material is preferably positioned an absorbent material 55 for any H₂O not retained by the condenser 24, and upstream of this latter item at least one SO₂-absorbent material 56 may be optionally positioned. This layout of the materials making up the filter considerably aids the regeneration stage, which, as already mentioned, occurs with the flow in the opposite direction, so that, during regeneration, any SO₂ and water do not pass through, and therefore have no effect on the CO₂-absorbent materials. The latter are then treated by the flow of regenerating gas in such a way that the fresh gas first comes into contact with the areas most loaded with CO₂ then little by little moving onto the least loaded areas, towards the end of its path. This improves the regeneration conditions and effects which, thanks also to the other construction details of the filter and its reduced thermal mass, may be completed and the filter cooled within a very short period of time, typically between 3 to 8 minutes.

A fan assists with speeding up the filter cooling process, in order to complete the regeneration process in times that are essentially equal to those required for analysis.

1. A CO₂-absorption device within an elemental analysis instrument consisting of at least one combustion reactor and one detector connected by a pneumatic line for the analysis of gasses exiting from the combustion reactor, along which is positioned said CO₂-absorption device, downstream of the combustion reactor and upstream of the detector, characterised in that said device consists of two regenerable CO₂ filters, one or more valve means for supplying gas undergoing analysis to one of said filters, alternating with the other filter for each consecutive analysis, and for supplying a regenerative flow of wash gas to the second filter, in the opposite direction with respect to the direction taken by the gas undergoing analysis in the same filter, as well as means for temporarily heating the filter during the regeneration stage.

2. A device according to claim 1, characterised in that said filters each contain a packing of material or CO₂-absorbent material, such materials being selected and/or arranged in order to provide absorbent power that increases from the inlet to the outlet in the direction taken by the gas undergoing analysis.

3. A device according to claim 2, characterised in that said packing materials have a granulometry that decreases from the inlet to the outlet of each filter.

4. A device according to claim 2, characterised in that the CO₂-absorbent materials consist of molecular sieves.

5. A device according to claim 2, characterised in that it comprises at least one H₂O-absorbant material located upstream of the CO₂-absorbent materials, in relation to the direction taken by the gas undergoing analysis inside the filter.

6. A device according to claim 5, characterised in that the H₂O-absorbent material consists of silica gel or activated alumina.

7. A device according to claim 5, characterised in that it comprises at least one SO₂-absorbant material located upstream of the H₂O-absorbent materials, in relation to the direction taken by the gas undergoing analysis inside the filter.

8. A device according to claim 7, characterised in that the SO₂-absorbent material consists of activated charcoal or silica gel.

9. A device according to claim 1, characterised in that each filter has an essentially elongated tubular configuration, with a reduced diameter with respect to its length.

10. A device according to claim 7, characterised in that each filter has an internal diameter comprised of between 4 mm and 10 mm, and a length comprised of between 0.5 m and 2 m.

11. A device according to claim 9, characterised in that the body of each filter has a side wall with a thickness not greater than 1 mm, made from a thermoconductive material, around which is wound at least one hearting element.

12. A device according to claim 11 characterised in that said heating element is in the form of a wire simultaneously acting as a heating element and a temperature measuring element.

13. A device according to claim 11, characterised in that said heating element wire is coiled with variations in pitch to give rise to differential degrees of heating along said filter tube.

14. A device according to claim 11 characterised in comprising means for a direct application of the electrical current to the side walls of the filter.

15. A device according to claim 1, characterised in that the valve means are constituted by three-way, two position valves.

16. A device according to claim 1, characterised in that the valve means are constituted by a single ten-way, two position valve.

17. An elemental analysis instrument comprising a combustion reactor, means for alternately supplying a carrier gas and O₂ to the combustion reactor and at least one detector, characterised by comprising, in its pneumatic circuit from the reactor to the detector, a CO₂-absorbent device according to claim 1.

18. An elemental analysis instrument according to claim 17, characterised by comprising an H₂O trap upstream of the CO₂-absorption device within the pneumatic circuit.

19. An elemental analysis instrument according to claim 17, characterised in comprising a reduction reactor downstream of the combustion reactor within said pneumatic circuit.

20. An elemental analysis instrument according to claim 17, characterised in that said detector is a nitrogen detector.
